(19) United States
(12) Patent Application Publication
(10) Pub. No.: US 2026/0154664 A1
(43) Pub. Date: Jun. 4, 2026

(54) AI-Powered Mobile App for Family Sharing with Interactive Challenges

(71) Applicants: Christopher Patrick, Las Vegas, NV (US); Mark Colombo, Truckee, CA (US)

(72) Inventors: Christopher Patrick, Las Vegas, NV (US); Mark Colombo, Truckee, CA (US)

(21) Appl. No.: 18/968,001

(22) Filed: Dec. 4, 2024

(51) Int. Cl. G06Q 50/00; G06Q 30/0226; H04L 67/55

(52) U.S. Cl. CPC G06Q 10/40; G06Q 30/0226; H04L 67/55

(57) ABSTRACT

An AI-powered mobile app for family sharing or special group sharing in which a family group or special group is created, information is provided by the group leader and other family members to develop curated data which is used by AI to create customized questions, interactive challenges, gamification, events, virtual events, wellness check-ins, and a reward system based on earned points to transform everyday activities into fun and engaging experiences. The continued use of the AI-powered mobile app of the present subject matter is designed to bring families closer together by fostering deeper emotional connections and shared experiences.

### FIELD OF INVENTION

The present invention relates an AI-powered mobile app designed to bring families or special groups together by fostering deeper emotional connections and shared experiences. More particularly, the AI-powered app uses curated data to develop customized activities of interest to the specific family group or special group.

### BACKGROUND OF THE INVENTION

In this digital age, it is challenging to keep families connected due to physical distances and busy schedules. Indeed, modern families, especially those living a distance from one another, struggle to maintain close connections and meaningful interactions. Typical family management tools which focus on logistics, such as lists, calendars and event scheduling, productivity, and finances do not facilitate the strengthening of family bonds. While such apps are useful for efficiency and planning among group members, they do not place any emphasis on emotional connections or shared experiences. Missed connections, surface-level conversations, difficulty in staying engaged with other family members, and limited family activities all contribute to family members growing apart from one another.

### PRIOR ART

There have been advancements in the prior art in developing cloud-based family and social group private networks. For example, U.S. Pat. No. 9,712,468 to Patel discloses a virtual private network for family members having shared interests in each other's health, finances, travel, calendars, scheduled events, debts, and physical access to assets. While the intent of Patel is to assist family members in helping one another logistically, it involves a utilitarian approach. Patel does not create means to foster greater emotional connections or shared experiences by developing interactive games and challenges, nor does Patel use AI to curate data from the family members and analyze curated data to develop customized challenges those specific interests in pursuit of furthering and maintaining deep emotional bonds.

WO 2023/022291 A1 to Eppal Co., Ltd. appears to provide a terminal enabling communication between family members for sharing life information. In CN 110971691A to Ren Yi, a parent-child interaction method comprising information sharing and communicating among family members and particularly relates to learning communication. KR 2018/0032449A to Jitin Co. is directed to a system and method for managing a family network using a smart device, which are connected to a family management server through wired or wireless internet by a personal computer or smart device. Family members are registered to provide a tree of ancestors, management of events such as marriages, births, and deaths to develop an accurate family tree. U.S. Pat. No. 10,880,250 B2 to Chakroborty et al. relates to a method and system of private messaging in a social or family network. None of these prior art references contemplate a family or social group that provides AI-generated challenges, games, and rewards based on curated data to create a fun dynamic which strengthens family bonds and nurtures emotional well-being from everyday experiences and tasks. Rather, these conventional platforms focus on lists, calendars, and productivity in a logistical and utilitarian manner.

Accordingly, a need still exists for an AI-powered mobile app that uses curated data from information provided by each member of a group and from shared activities and experiences prompted by the app which will foster family bonds and enhanced emotional insights to bring families closer together. Such a mobile app should create a fun dynamic while providing AI-powered customized challenges, interactive games, and creative projects based on the unique interests of each of the members of the family group. Such a mobile app also should be proactive, provide a rewards participation program with points which can be redeemed for family-approved rewards, an earned badge system, and should create a competitive leaderboard such that everyday tasks become enjoyable experiences. Such an AI-powered mobile app also should promote holistic family wellness through regular check-ins and shared health goals. And, such a mobile app should facilitate mobile virtual gatherings, enabling long-distance families to stay connected. Finally, such a mobile app should be adaptable to friend groups, social groups, sport teams, and other family-by-love groups along with the traditional family groups.

### SUMMARY OF THE INVENTION

The invention of the present subject matter relates to an AI-powered mobile app for family sharing with interactive challenges. The mobile app can be managed solely as a family member group, or can be adapted easily for other social groups.

Accordingly, it is an object of the present subject matter to provide an AI-powered mobile app for family sharing with interactive challenges that fosters deeper emotional connections and shared experiences between the family members.

It is an additional object of the present subject matter to provide an AI-powered mobile app for family sharing with interactive challenges that uses AI to determine and understand each family member's preferences and tailoring activity suggestions, emotional insights, and personal support to ensure that every member of the family feels included and part of the family group.

It is another object of the present subject matter to provide an that creates opportunities for engagement through AI-powered customized experiences.

It is still another object of the present subject matter to provide an AI-powered mobile app for family sharing with interactive challenges that uses AI-customized challenges, interactive games and creative projects based on the curated data of the specific interests of each member of the family group.

It is a yet another object of the present subject matter to provide an AI-powered mobile app for family sharing with interactive challenges which promotes proactive activities including a rewards participation program with earned points that can be redeemed for a family-approved reward.

It is a further object of the present subject matter to provide an which includes a competitive leaderboard to increase the likelihood that everyday tasks are a fun dynamic and become enjoyable experiences.

It is yet a further object of the present subject matter to provide an AI-powered mobile app for family sharing with interactive challenges which facilitates virtual gatherings, enabling long distance family members or group members to remain connected.

It is still a further object of the present subject matter to provide an AI-powered mobile app for family sharing with interactive challenges which promotes holistic family wellness through regular check-ins and shared health goals.

It is an additional object of the present subject matter to provide an AI-powered mobile app for family sharing with interactive challenges having interactive challenges, gamification through leaderboards and rewards, and shared activities.

It is an additional object of the present invention to provide an which transform everyday moments into fun and engaging experiences, thereby creating meaningful interactions to strengthen family bonds and nurture emotional well-being.

These and other objects of the present subject matter are accomplished by providing an AI-powered mobile app for family sharing in which a family group is created, data provided by the group leader and other family members is curated by AI to create customized questions, interactive challenges, gamification, events, virtual events, wellness check-ins, and a reward system based on earned points to transform everyday moments into fun and engaging experiences. The continued use of the AI-powered mobile app of the present subject matter is designed to bring families closer together by fostering deeper emotional connections and shared experiences.

### BRIEF DESCRIPTION OF DRAWINGS

FIG. 1 is a flow diagram of the AI-powered mobile app of the present subject matter illustrating the onboarding sequence of steps.

FIG. 2 depicts the welcome greeting and the first step of the onboarding sequence of the AI-powered mobile app of the present subject matter referred to as Family Genie.

FIG. 3 shows several onboarding images of the AI-powered mobile app of the present subject matter in the form of questions to initiate the formation of a Family Group preferences customization page of the Family Genie.

FIG. 4 shows several images of the AI-powered mobile app of the present subject matter illustrating the completion of the profile.

FIG. 5 is an image depicting the Family Genie tour for invited members of the AI-powered mobile app of the present subject matter.

FIG. 6 shows the three primary challenges utilized by the AI-powered mobile app of the present subject matter.

FIG. 7 depicts the three primary challenges utilized by the AI-powered mobile app of the present subject matter.

FIG. 8 illustrates the wellness check-in utilized by the AI-powered mobile app of the present subject matter.

FIG. 9 shows several images utilized by the AI-powered mobile app of the present subject matter to curate additional data from each member.

FIG. 10 shows several images associated with the reward system utilized by the AI-powered mobile app of the present subject matter.

FIG. 11 depicts a Notifications image utilized by the AI-powered mobile app of the present subject matter.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “AI-powered mobile app”, “family sharing mobile app, “mobile app for family sharing and special group sharing”, “mobile app”, “Family Genie”, derivatives thereof and similar terms may be used throughout the specification and it is to be understood that such terms are interchangeable and all refer to the AI-powered mobile app for family sharing with interactive challenges of the present subject matter.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

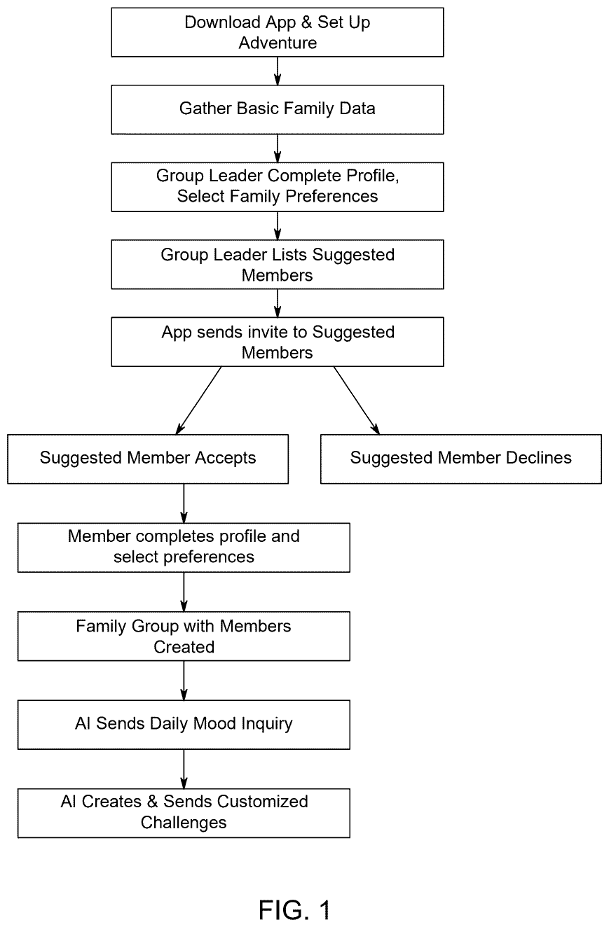

The AI-powered mobile app for family sharing with interactive activities of the present subject matter will sometimes hereinafter be referred to as Family Genie. The following onboarding sequence as depicted in FIG. 1 will be directed to the creation of a family account. However, it is to be understood that any special group can utilize this AI-powered mobile app to create a special group account aimed at strengthening bonds and building shared memories.

FIG. 1 illustrates a block diagram depicting the several steps involved in setting up the family group account. These steps include downloading the Family Genie mobile app, setting up the family adventure which includes responding to several questions of to collect certain relevant family information, registering the group and group leader, completing the group leader profile, and sending invitations to other family members to join the family group. Those family members who respond affirmatively to the invitation will be prompted for selected information. Once the family group has been established, the Family Genie, powered by AI, will create customized family challenges based on the curated data of each family member.

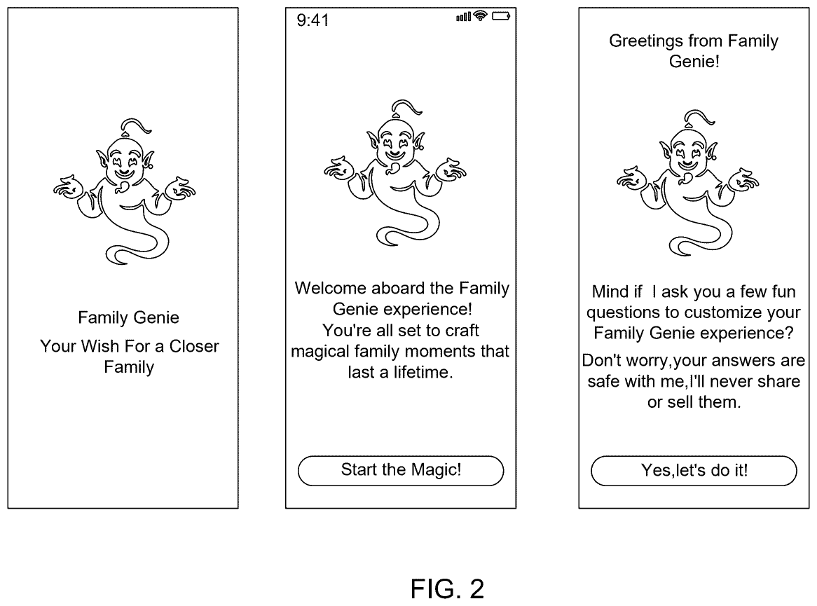

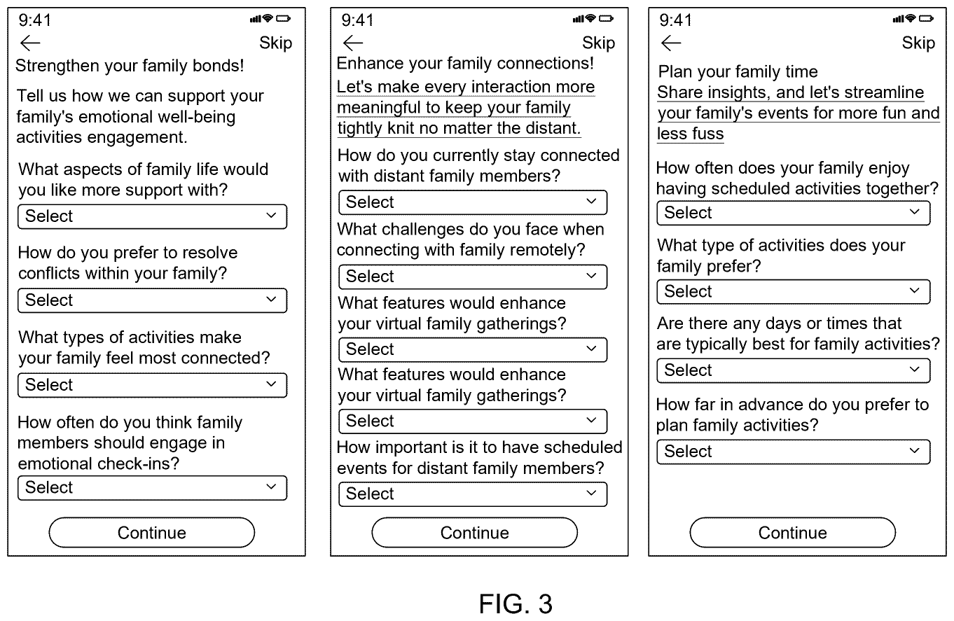

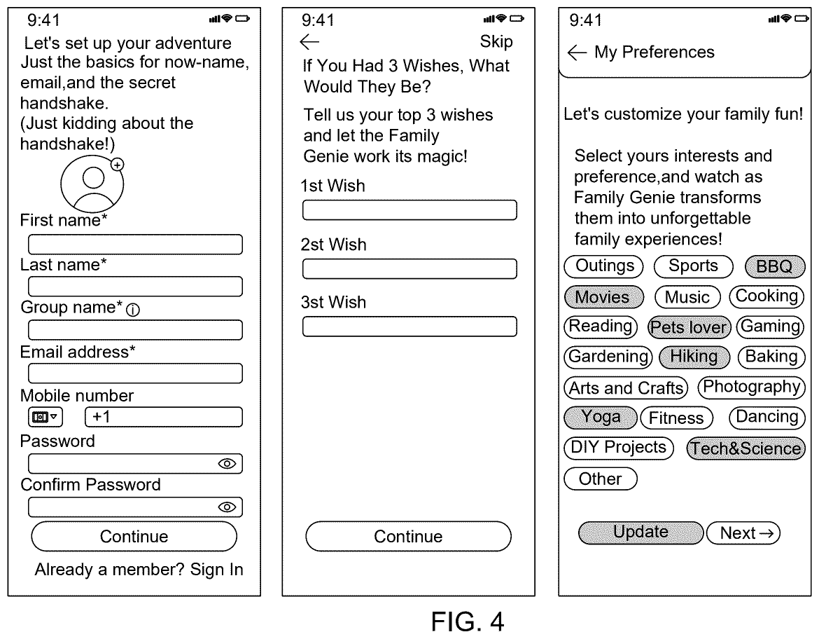

As shown in FIG. 2, once a user downloads the mobile app for Family Genie, the user will be greeted by the Family Genie and requested to reply to a few fun questions which will begin the customization process of the mobile app for that specific Family Group. FIG. 3 illustrates examples of questions to which the user will be asked to respond. The replies to these questions will be the foundation of the curated data of this specific Family Group thereby enabling AI to tailor activities and events for this Family Group. Another part of the first step of the onboarding sequence will be the creation and naming of the family account, e.g. The Smith Family, which will be completed by the initial user who is the account administrator and hereinafter referred to as the group leader or family leader. The group leader first completes the profile page which will include basic information such as First name, Last name, Group name, Email Address, Mobile number, and of course a user password, as shown in FIG. 4. Family Genie also will prompt the group leader to select an avatar and upload a photograph.

In one embodiment, it is contemplated that other basic user information including, for example, home address, date of birth, marital status, and the like may be collected to further complete basic information of the group leader. Family Genie also may prompt the user for a second tier of information, including for example, schools attended, places lived, states the visited, sports participation, and marriage information, to name but a few. All the second-tier information will be used as additional curated data which AI will analyze to customize different activities and events.

Once the Group Account is created, the Family Genie will prompt the group leader to customize the account by selecting from a plurality of interests and preferences as shown in FIG. 4. Once this first onboarding step has been completed, the Group Account is established.

The second onboarding step is inviting other members to join the family group. Family Genie will prompt the group leader to add one or more individuals to join the Family Group by entering each user's name, and contact information, such as a mobile telephone number and email address. Family Genie will send an invitation to each of the identified individuals, inviting each to join the Family Group, along with a link to download the AI-powered mobile app of the present subject matter.

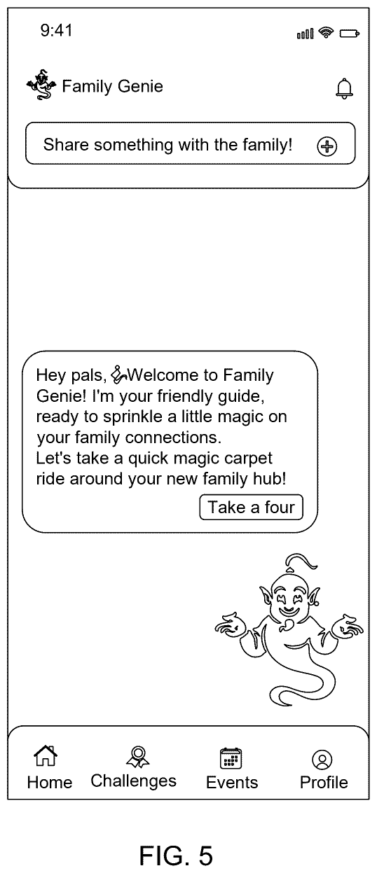

In the third onboarding step, every individual who accepts the Family Genie invitation will be taken on a Family Genie tour of the mobile app as depicted in FIG. 5 and prompted to complete the basic profile information, choose an avatar, upload a photograph, select from the plurality of interests and preferences, and complete any second tier of profile information as prompted by the Family Genie. FIG. 5 illustrates a preferred embodiment of the basic page comprising a notification bell, text message box, home page icon, challenges icon, events icon, and profile icon. Each member can revise his/her profile information at any time.

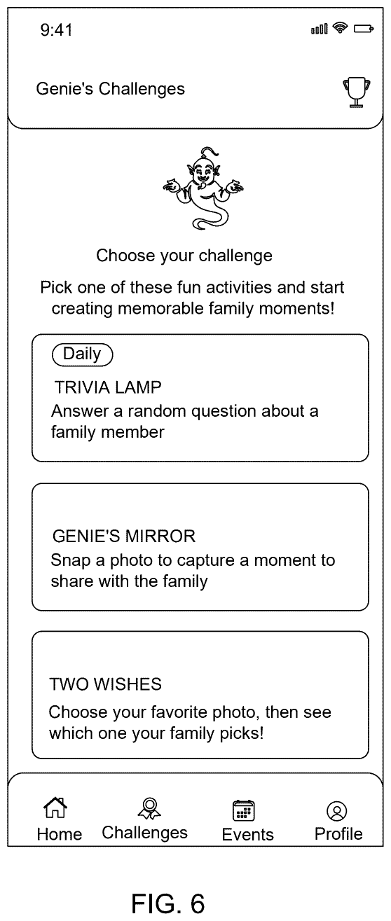

Once the family group has been populated by a plurality of members, the AI will review and analyze all the curated data thus collected, including the inputted information and photographs uploaded by each member, along with the interests and preferences selected by each user. From this data, Family Genie will create customized activities for each member of the family group, including the three daily challenges depicted in FIG. 6: Trivia Lamp, Genie's Mirror and Two Wishes.

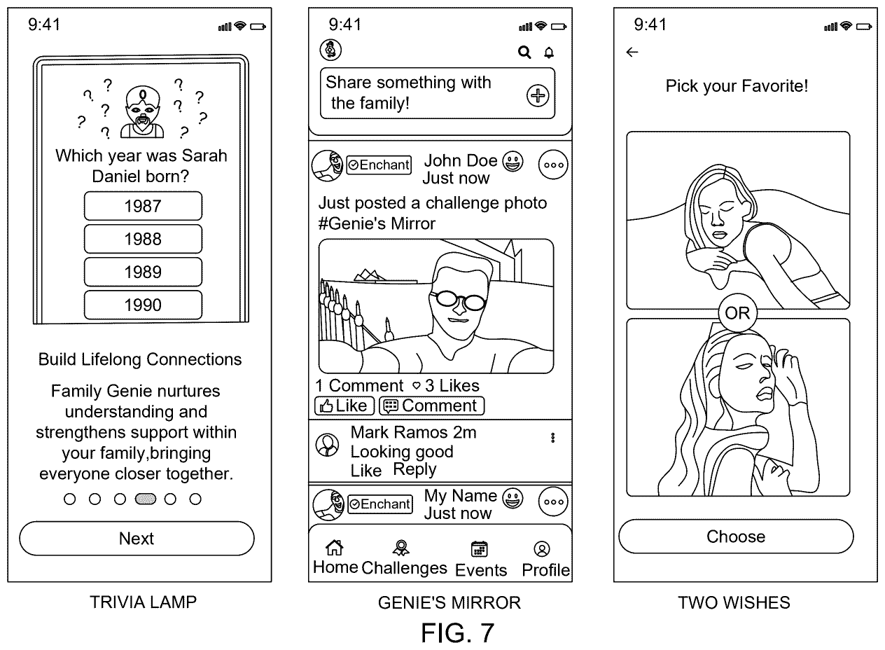

Referring now to FIG. 7, Trivia Lamp is a trivia challenge in the form of a question with a multiple-choice answer format which will be sent to each member of the family group. In a preferred embodiment, the Trivia Lamp is a daily challenge. The Trivia Lamp question may be a customized question about another family member based on the curated data. For example, a customized question might be “What is Sarah Doe's Favorite Ice-Cream” with four ice cream flavors listed in the multiple-choice format. Or, the trivia question could be a random question based on a selected preference or interest, for example a movie trivia question. An example of a movie trivia question is “which of the following movies did not win an Academy Award”. In this challenge, a point is earned by each member answering the question and extra point(s) are earned for answering the Trivia Lamp question correctly. The Trivia Lamp challenge is designed to nurture understanding and strengthen support within the family group, bringing everyone closer together.

A second challenge developed to create memorable family moments is the Genie's Mirror. In a preferred embodiment, Genie's Mirror is a daily challenge. Family Genie will send a request to each member of the Family Group to snap a photo to capture a moment and share it with the rest of the family members. Each member who uploads a photo in response to the request will earn a point. Each uploaded photo will be shared with the other members of the Family Group.

The third challenge is referred to as Two Wishes. In a preferred embodiment, the Two Wishes is a daily challenge. In this challenge, Family Genie will send two photographs to each member of the Family Group and ask each member to choose which photograph is his or her favorite. Each member selecting a favorite will earn a point. AI will determine and send a notification with the number of members who responded to the challenge, and which family members chose which photograph.

It is contemplated to be within the scope of the present subject matter that the AI-powered mobile app will develop other challenges based on the curated data of the Family Group. Such other challenges will be suggested to group leader as additional challenges to the preferred daily three challenges.

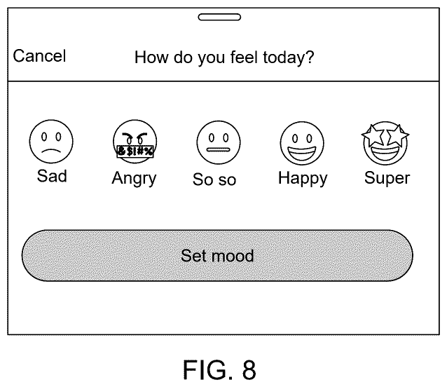

A very significant feature of Family Genie is Wellness Tracking, determining the mental mood and physical health of each member of the Family Group. This feature includes a Daily Mood Notification prompt which asks each member to indicate his or her mood by choosing from a plurality of emoji symbols. Referring now to FIG. 8, in one embodiment, Family Genie sends each member a notification to select a mood at that particular moment from five emoji symbols: (1) sad, (2) happy, (3) angry, (4) so-so and (5) super. The AI-powered Family Genie will review and analyze each mood notification and suggest how to support each member. For example, Sarah may indicate the she is super and other members can message her a high-five emoji. Or, if Derek is sad, Family Genie may suggest taking him out for ice-cream as Derek indicated in his onboarding information that ice-cream is a favorite thing to do when he is sad.

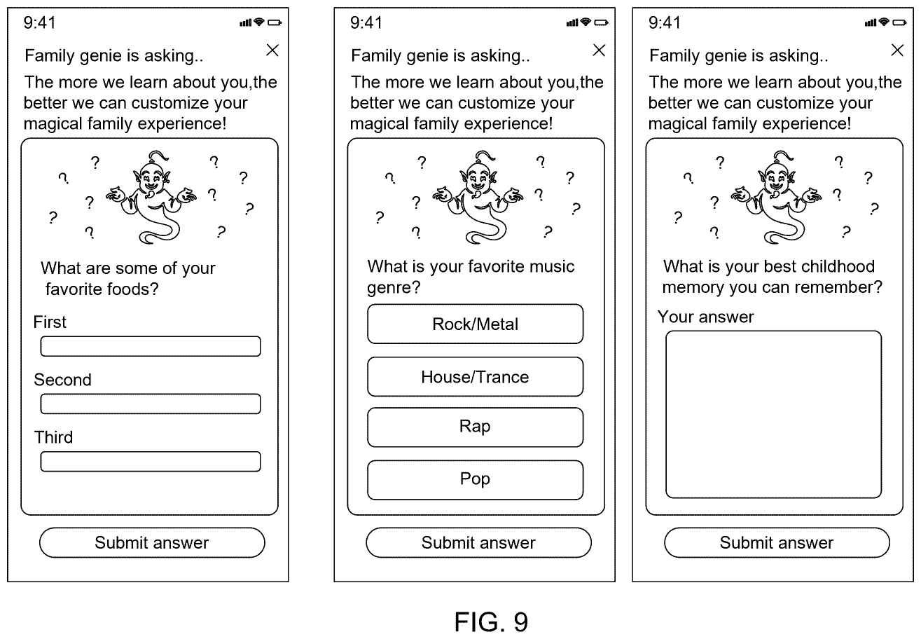

Bringing families closer together can include learning more about each family member. With consideration of this objective, Family Genie may send out a “Family genie is asking” query, examples of which are shown in FIG. 9. With these queries, AI is developing additional curated data to pose new trivia lamp questions and other challenges. As a result, the members'replies will strengthen the bonds between one another as they learn more about their fellow members. It will be understood that the Family Genie queries can be in multiple-choice format or can be in open-ended text format as shown.

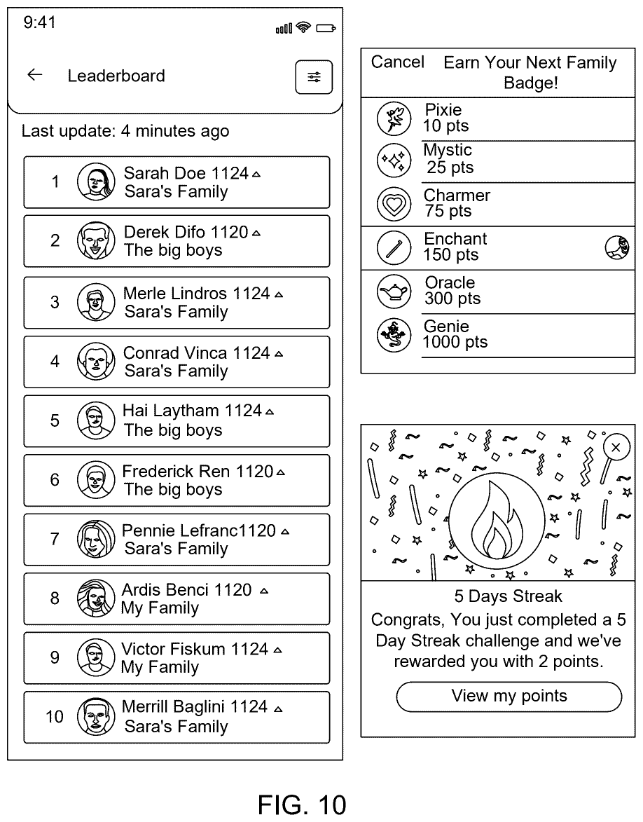

The AI-powered mobile app of the present subject matter also includes a rewards program with a challenge leaderboard and badge system. The purpose of the rewards program is to maintain a fun dynamic and to encourage daily participation. Each question or activity prompted by Family Genie Points will earn one or more points by each member replying to the question or activity challenge. Referring to FIG. 10, The Leaderboard shows how many points each member has earned and each member's standing on the Leaderboard. Badges, based on a predetermined number of points, also can be earned. While six badges are shown, it will be apparent that the number of badges can be increased without departing from the spirit of this invention. In addition, points can be earned when completing a streak, such as a five-day streak. Family Genie will send daily notifications to each member of the Family Group advising each member of the several reward systems, who is atop the leaderboard, who is climbing up or falling down the ladder and which members have earned which badges.

Another powerful feature of the AI-powered mobile app of the present subject matter is the creation of events to bring the members of the Family Group together. Events can be suggested by Family Genie based on the curated data, by the group leader or a combination of both. Of course, any member of the Family Group can send a group message suggesting a group event as well. To determine the kind of events that may have the best potential for success within the group, during the onboarding process, Family Genie will ask the group leader whether all the members live in the same house, same town, nearby areas or are distant from one another. For example, if most or all the members live within a suitable distance, Family Genie may suggest a barbecue, bowling night or local concert. Or, for members who live a distance away, Family Genie may suggest a virtual event, suitable examples might be a virtual movie night while using a Facetime™ type app, an online game app or may suggest a virtual baking event where each member purchases specific ingredients and bakes an item, all while using a Facetime™ type app. Once an event has been suggested and confirmed by the group leader, a selection of dates and times is chosen and Family Genie forwards a notification to each of the Family Group members about the event. Once again, point(s) are earned by each member participating in the event.

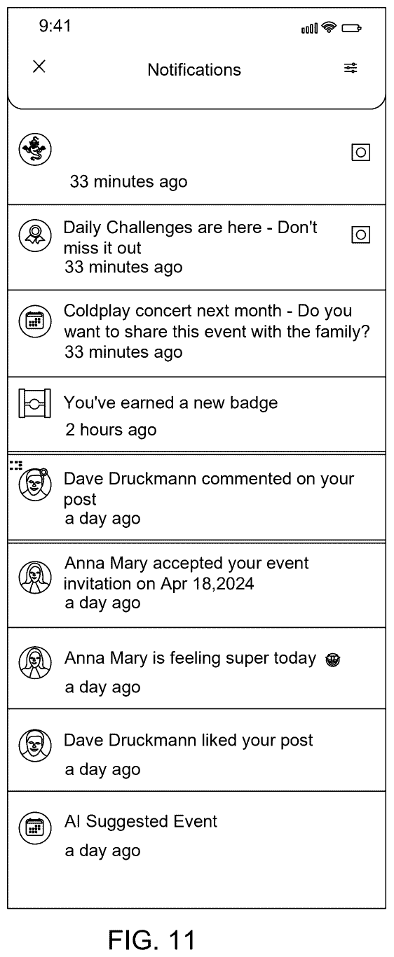

As the primary objective of Family Genie is to bring members of a group closer together, reinforce emotional connections and nurture emotional wellness, the AI-powered mobile app will send periodic notifications, some of which have been discussed. Some notifications will be in the form of App notifications, particularly reminders, informing members of earned badges, leadership points, daily challenges, and AI suggested events. Other notifications will be User notifications, such as updates, in which a user comments/likes/shares a mood, receives an invitation, and accepts or rejects an event. FIG. 11 illustrates several such notifications.

It also is contemplated that as the AI-powered mobile app continues to build out and gathers and curates more data, Family Genie can enable each member of a group to use the Family Group to send and share messages with one another, such as “I just arrived at the airport, who's going to pick me up”? And each member will be able to suggest and create events for the Family Group.

All the activities and events hereinbefore described have been designed to bring the members of the Family Group closer together and to strengthen their bonds, while engaging in activities that provide a fun dynamic.

It is to be understood and will be obvious by those skilled in the art that while the core purpose of the AI-powered mobile app of the present subject matter is to foster emotional connections among families, this mobile app can be adapted easily for other types of special groups. For example, a high school friend group can share nostalgic stories, photos, and chosen interests for AI to develop tailored interactive challenges. Similarly, a sport team group can be created to track achievements, set team goals, and share highlights, all of which will be AI curated to create customized challenges. This flexibility ensures that the mobile app of the present subject matter is effective and productive for a wide range of groups including traditional families, close-knit friend groups, and even professional teams. Indeed, this AI-powered mobile app is design to strengthen bonds and build shared experiences among most any special group.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for. . . . ”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. An AI-powered mobile app for sharing among a group having a plurality of selected members, comprising creating said group with a designated group leader, gathering information provided by each of said plurality of selected members to develop AI curated data, and using said AI curated data to create and send wellness checks, customized questions, interactive challenges, gamification, and special events for said group having a plurality of selected members.

2. The AI-powered mobile app in accordance with claim 1, wherein the use of said AI curated data is designed to foster and strengthen bonds and emotional insights between each of said plurality of selected members.

3. The AI-powered mobile app in accordance with claim 1, further comprising a reward program based on an earned points system to transform daily challenges into fun and engaging experiences among said group having a plurality of selected members.

4. The AI-powered mobile app in accordance with claim 1, wherein said wellness check is a daily mood notification sent to each of said plurality of selected members prompting each of said plurality of selected members to select from a plurality of mood emojis to indicate and respond to each member's current mood.

5. The AI-powered mobile app in accordance with claim 4, wherein each of said plurality of selected members will be notified of the results of said daily mood notification and will offer suggestions of support based on said results.

6. The AI-powered mobile app in accordance with claim 1, wherein the customized activities developed by the AI curated data include a daily trivia challenge, a daily capture-the-moment challenge and sharing it with said group by uploading a photograph, and a daily select-your-favorite challenge which requires each of said plurality of members to choose a favorite photograph from at least a pair of photographs generated and sent by the AI.

7. The AI-powered mobile app in accordance with claim 1, wherein said information comprises basic profile information including first name, surname, email address, mobile telephone number, the selection of a username, the selection of an avatar and the uploading of a photograph.

8. The AI-powered mobile app in accordance with claim 1, wherein said information to develop AI curated data further comprises residential address, date of birth, marital status, names of schools attending, places lived, states visited, sports participation and marriage information.

9. The AI-powered mobile app in accordance with claim 1, wherein said information to develop AI curated data further comprises a selection of preferences and interests provided by each of said plurality of selected members.

10. The AI-powered mobile app in accordance with claim 1, wherein said information to develop AI curated data further comprises a daily query sent to each of said plurality of members.

11. The AI-powered mobile app in accordance with claim 10, wherein said daily query is a query with a multiple-choice answer format.

12. The AI-powered mobile app in accordance with claim 10, wherein said daily query is an open-ended text query.

13. The AI-powered mobile app in accordance with claim 3, wherein said reward program includes a challenge leaderboard based on earned points and a badge system based on earned points, said AI-powered mobile app sending daily notifications to each of said plurality of selected members with information relating to each member's standing in said leaderboard and said badge system.

14. The AI-powered mobile app in accordance with claim 1, wherein said AI will provide event suggestions to said group leader based on said curated data.

15. The AI-powered mobile app in accordance with claim 1, wherein said group having a plurality of selected members is a family group having a plurality of family members.

16. An AI-powered mobile app for sharing among a group having a plurality of selected members, said group being formed by an onboarding process comprising:
a. downloading said AI-powered mobile app;
b. providing basic information about said group;
c. designating a group leader;
d. providing profile information by said group leader;
e. determining selected group preferences and interests by said group leader;
f. suggesting a plurality of members for said group by said group leader;
g. sending an invitation to join said group from said suggested plurality of members;
h. gathering profile information from each of said plurality of members who accepted said invitation to join said group;
i. gathering second tier information from said group leader and said plurality of members who accepted said invitation to join said group;
j. developing AI curated data from said profile information and said second tier information;
k. using said AI curated data to create, customize, and send wellness checks, customized questions, interactive challenges, gamification, and special events to each of said plurality of members of said group, and
l. providing a reward program with an earned point system for each response to said wellness checks, said customized questions, said interactive challenges, said gamification, and said special events.

17. The AI-powered mobile app in accordance with claim 16, wherein said wellness check is a daily mood notification sent to each of said plurality of selected members prompting each of said plurality of selected members to select from a plurality of mood emojis to indicate and respond to each member's current mood.

18. The AI-powered mobile app in accordance with claim 16, wherein the customized activities developed by the AI curated data include a daily trivia challenge, a daily capture-the-moment challenge and sharing it with said group by uploading a photograph, and a daily select-your-favorite challenge which requires each of said plurality of members to choose a favorite photograph from at least a pair of photographs generated and sent by the AI.

19. The AI-powered mobile app in accordance with claim 16, wherein said reward program includes a challenge leaderboard based on earned points and a badge system based on earned points, said AI-powered mobile app sending daily notifications to each of said plurality of selected members with information relating to each member's standing in said leaderboard and said badge system.

20. The AI-powered mobile app in accordance with claim 1, wherein said AI will provide event suggestions to said group leader based on said curated data.

21. The AI-powered mobile app in accordance with claim 1, wherein said group having a plurality of selected members is a family group having a plurality of family members.
